(19) United States
(12) Patent Application Publication
(10) Pub. No.: US 2012/0011188 A1
(43) Pub. Date: Jan. 12, 2012

(54) Distributed processing system

(75) Inventor: Tomotake Nakamura, Kawasaki (JP)

(73) Assignee: FUJITSU LIMITED, Kawasaki (JP)

(21) Appl. No.: 13/137,862

(22) Filed: Sep. 19, 2011

Related U.S. Application Data
(63) Continuation of application No. PCT/JP2009/055518, filed on Mar. 19, 2009.

(51) Int. Cl. G06F 15/16

(52) U.S. Cl. 709/201

(57) ABSTRACT

A distributed processing system includes a plurality of information processing apparatuses, each of the information processing apparatuses including a transferring unit that divides data to be processed including data elements for each of which one of the information processing apparatuses is set for processing, that assigns divided data to the information processing apparatuses in the distributed processing system, and that transfers the divided data assigned to a different information processing apparatus to the different information processing apparatus; an allocation unit that allocates the data elements included in the divided data which is assigned to own information processing apparatus by the transferring unit in the own information processing apparatus or by the transferring unit in a different information processing apparatus, to an information processing apparatus that processes the data element; and a data processing unit that processes the allocated data elements.

### CROSS-REFERENCE TO RELATED APPLICATION

This application is a continuation of International Application No. PCT/JP2009/055518, filed on Mar. 19, 2009, the entire contents of which are incorporated herein by reference.

### FIELD

The embodiments discussed herein are directed to a distributed processing system.

### BACKGROUND

An information processing technology called distributed computing has been used. When a predetermined process is performed, a distributed processing system that uses distributed computing distributes data to be processed and allows a plurality of information processing apparatuses to process, in parallel, the distributed data.

Two examples of the conventional distributed processing will be described using FIGS. 9 and 10. FIGS. 9 and 10 are schematic diagrams each illustrating an example of conventional distributed processing. In the example illustrated in FIG. 9, an information processing apparatus 10a includes data D10. The data D10 is bulk data and includes data elements A1 to A4, B1 to B4, and C1 to C4 that correspond to data processed in predetermined units.

From among data elements A1 to A4, B1 to B4, and C1 to C4, data elements to be processed are assigned to information processing apparatuses 10a to 10c. In this case, it is assumed that the information processing apparatus 10a processes the data elements A1 to A4 included in the data D10; the information processing apparatus 10b processes the data elements B1 to B4 included in the data D10; and the information processing apparatus 10c processes the data elements C1 to C4 included in the data D10.

In such a case, as illustrated in FIG. 9, the information processing apparatus 10a transmits the data D10 to the information processing apparatus 10b and the information processing apparatus 10c. Subsequently, the information processing apparatus 10a extracts the data elements A1 to A4 from the data D10. Then, the information processing apparatus 10a processes the extracted data D10A. If the information processing apparatus 10b receives the data D10 from the information processing apparatus 10a, the information processing apparatus 10b extracts the data elements B1 to B4 from the data D10 and processes the extracted data D10B. Furthermore, the information processing apparatus 10c extracts the data elements C1 to C4 from the data D10 and processes the extracted data D10C.

In the following, another example of the conventional distributed processing will be described using FIG. 10. In the example illustrated in FIG. 10, in a similar manner as illustrated in FIG. 9, it is assumed that data elements to be processed are assigned to the information processing apparatuses 10a to 10c. In such a case, the information processing apparatus 10a extracts the data elements A1 to A4 from the data D10. Furthermore, the information processing apparatus 10a extracts the data elements B1 to B4 from the data D10 and allocates the extracted data D10B to the information processing apparatus 10b. Furthermore, the information processing apparatus 10a extracts the data elements C1 to C4 from the data D10 and allocates the extracted data D10C to the information processing apparatus 10c. Then, the information processing apparatus 10a processes the data D10A, the information processing apparatus 10b processes the data D10B, and the information processing apparatus 10c processes the data D10C.

Patent Document 1: Japanese Laid-open Patent Publication No. 10-207853

Patent Document 2: Japanese Laid-open Patent Publication No. 07-253953

However, with the conventional technology described above, there is a problem in that data processing takes a long time. Specifically, a data transmission process takes a long time if the distributed processing illustrated in FIG. 9 is used, and thus the data processing takes a long time as well. In the example illustrated in FIG. 9, the information processing apparatus 10a transmits the bulk data D10 to both the information processing apparatuses 10b and 10c. Accordingly, with the distributed processing illustrated in FIG. 9, because transmitting the data D10 takes a long time, data processing takes a long time accordingly.

Furthermore, if the distributed processing illustrated in FIG. 10 is used, because the load on the information processing apparatus that allocates the data elements increases, the data processing takes a long time. In the example illustrated in FIG. 10, the information processing apparatus 10a extracts data elements from the data D10 and allocates the extracted data elements to the information processing apparatuses 10b and 10c. Accordingly, with the distributed processing illustrated in FIG. 10, the load on the information processing apparatus 10a increases, and thus allocating the data elements takes a long time. Therefore, with the distributed processing illustrated in FIG. 10, the data processing takes a long time.

In FIGS. 9 and 10, a case in which three information processing apparatuses are arranged is illustrated; however, in practice, there may be a case in which a distributed processing system includes hundreds to tens of thousands of information processing apparatuses. Furthermore, the size of data processed by the distributed processing system is usually huge. Accordingly, if the conventional technology described above is used, because the data transmission process or the allocation process of data elements takes a long time, the time for data processing takes a long time.

The present invention is also effective as another aspect when components of the distributed processing system, descriptions, or any combination of components that are disclosed in the present invention are applied to methods, apparatuses, systems, computer programs, recording media, and data structures.

### SUMMARY

According to an aspect of an embodiment of the invention, a distributed processing system includes a plurality of information processing apparatuses, each of the information processing apparatuses including a transferring unit that divides data to be processed including data elements for each of which one of the information processing apparatuses is set for processing, that assigns divided data to the information processing apparatuses in the distributed processing system, and that transfers the divided data assigned to a different information processing apparatus to the different information processing apparatus; an allocation unit that allocates the data elements included in the divided data which is assigned to own information processing apparatus by the transferring unit in the own information processing apparatus or by the transferring unit in a different information processing apparatus, to an information processing apparatus that processes the data element; and a data processing unit that processes the allocated data elements.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a schematic diagram illustrating an example of distributed processing performed by a distributed processing system according to a first embodiment;

FIG. 2 is a schematic diagram illustrating an example of data processed by the distributed processing system according to the first embodiment;

FIG. 3 is a schematic diagram illustrating the configuration of an information processing apparatus according to the first embodiment;

FIG. 4 is a flowchart illustrating the flow of a process performed by an information processing apparatus storing therein data to be processed;

FIG. 5 is a flowchart illustrating the flow of a process performed by the information processing apparatus to which divided data is transferred from a different information processing apparatus;

FIG. 6 is a schematic diagram illustrating an example of distributed processing performed by a distributed processing system according to a second embodiment;

FIG. 7 is a schematic diagram illustrating an example of distributed processing performed by a distributed processing system according to the second embodiment;

FIG. 8 is a schematic diagram illustrating a computer that executes a distributed processing program;

FIG. 9 is a schematic diagram illustrating an example of conventional distributed processing; and

FIG. 10 is a schematic diagram illustrating an example of conventional distributed processing.

### DESCRIPTION OF EMBODIMENTS

Embodiments of the present invention will be explained with reference to accompanying drawings. The distributed processing system or the information processing apparatus is not limited to the disclosed embodiments.

### [a] First Embodiment

Distributed processing performed by a distributed processing system according to a first embodiment

First, distributed processing performed by a distributed processing system according to a first embodiment will be described. By using a plurality of information processing apparatuses, the distributed processing system according to the first embodiment performs a process for allocating data elements to the information processing apparatuses that are included in the distributed processing system.

An information processing apparatus in the first embodiment (hereinafter, referred to as a “first information processing apparatus”) divides data to be processed and assigns the divided data (hereinafter, referred to as the “divided data”) to all or some of the information processing apparatuses in the distributed processing system. Then, a first information processing apparatus transfers the divided data assigned to a different information processing apparatus to the different information processing apparatus to which the divided data has been assigned. Then, the first information processing apparatus allocates data elements, which are included in the divided data and are assigned to the first information processing apparatus, to an information processing apparatus that processes the data elements. Furthermore, the different information processing apparatus allocates data elements, which are included in the divided data and are transferred from the first information processing apparatus, to an information processing apparatus that processes the data elements. Then, each of the first information processing apparatus and the different information processing apparatus processes their respectively allocated data elements.

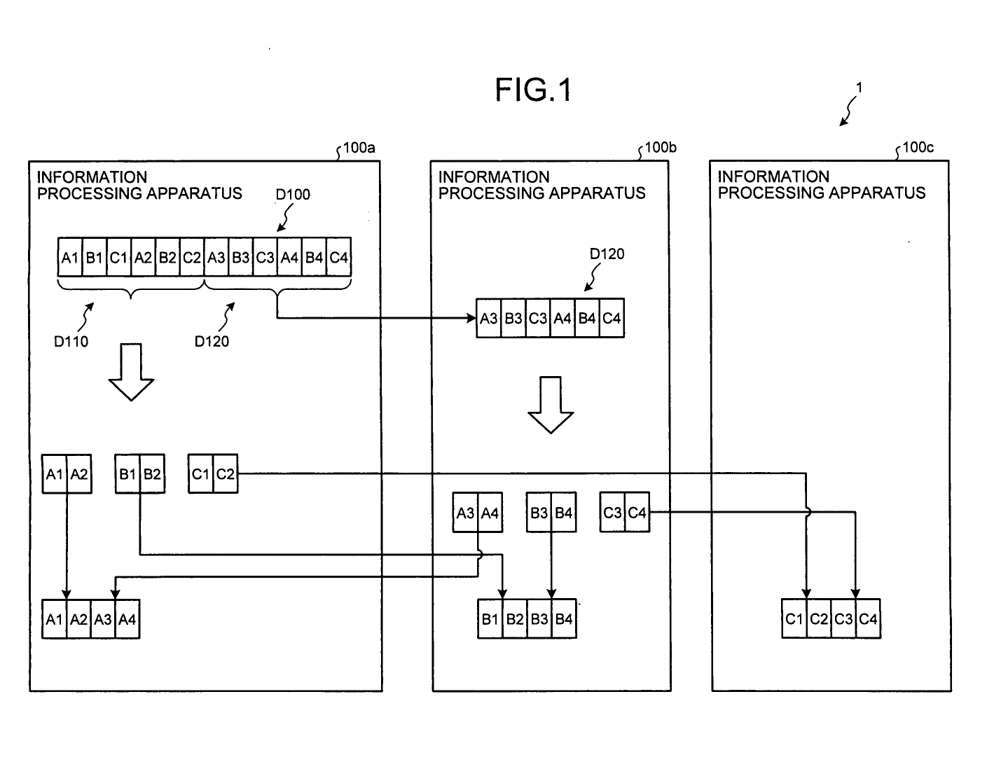

The distributed processing described above will be specifically described with reference to FIG. 1. FIG. 1 is a schematic diagram illustrating an example of distributed processing performed by a distributed processing system 1 according to the first embodiment. The distributed processing system 1 illustrated in FIG. 1 includes information processing apparatuses 100a to 100c.

The information processing apparatuses 100a to 100c processes, in a distributed manner, data D100 including data elements A1 to A4, B1 to B4, and C1 to C4. In the example illustrated in FIG. 1, the information processing apparatus 100a determines data elements that are processed by the information processing apparatuses 100a to 100c. Then, the information processing apparatuses 100a to 100c process data elements that are processed by themselves, i.e., the information processing apparatuses 100a to 100c.

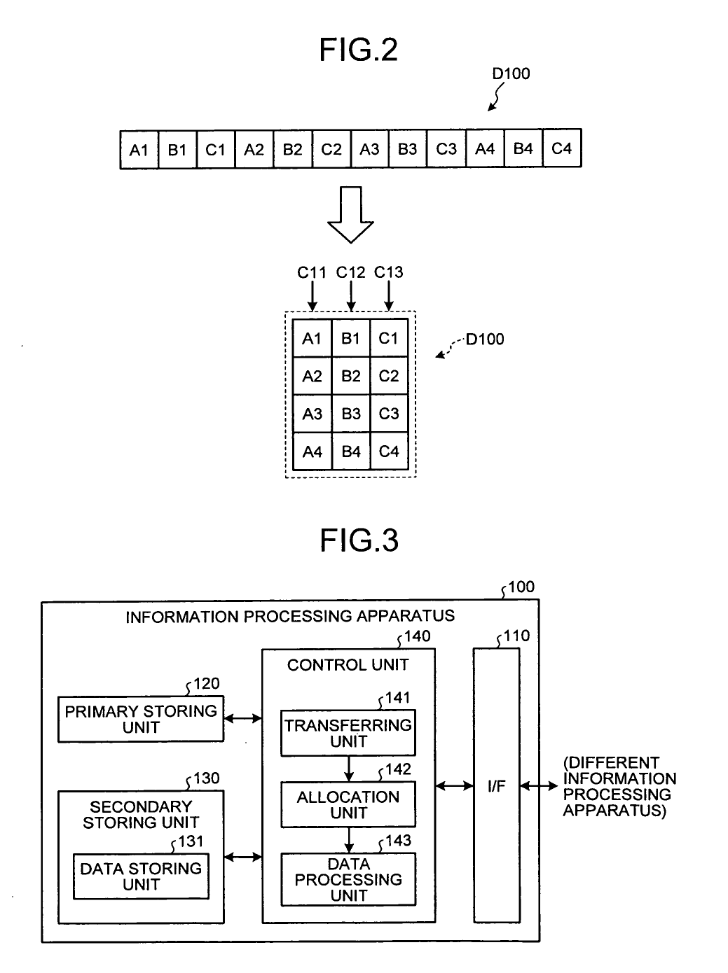

In the following, the data D100 that is processed by the distributed processing system 1 will be described with reference to FIG. 2. FIG. 2 is a schematic diagram illustrating an example of data D100 processed by the distributed processing system 1 according to the first embodiment. In the example illustrated in FIG. 2, the data elements A1 to A4, B1 to B4, and C1 to C4 are coded image data. Then, the data elements A1 to A4, B1 to B4, and C1 to C4 become an image G100 by being subjected to a process, such as decoding.

When processing the data D100, in some cases, the information processing apparatuses 100a to 100c may process data elements for each column of the image G100. For example, in the first embodiment, the information processing apparatus 100a processes the data elements corresponding to a column C11 of the image G100, the information processing apparatus 100b processes the data elements corresponding to a column C12 of the image G100, and the information processing apparatus 100c processes the data elements corresponding to a column C13.

As in the example in FIG. 1, it is assumed that the information processing apparatuses 100a to 100c process the data elements corresponding to each of the columns C11 to C13. Specifically, for the data D100, it is assumed that the information processing apparatus 100a processes the data elements A1 to A4, that the information processing apparatus 100b processes the data elements B1 to B4, and that the information processing apparatus 100c processes the data elements C1 to C4.

With this configuration, the information processing apparatus 100a divides the data D100 and assigns the divided data to all or some of the information processing apparatuses 100a to 100c. Then, the information processing apparatus 100a transfers the divided data to the information processing apparatus 100b or 100c to which the divided data has been assigned. In the example illustrated in FIG. 1, the information processing apparatus 100a divides the data D100 into divided data D110 and divided data D120, assigns the divided data D110 to the information processing apparatus 100a, and assigns the divided data D120 to the information processing apparatus 100b. Then, the information processing apparatus 100a transfers the divided data D120 assigned to the information processing apparatus 100b to the information processing apparatus 100b.

Subsequently, the information processing apparatus 100a allocates the data elements, which are included in the divided data D110 and are assigned to the information processing apparatus 100a, to an information processing apparatus that processes the data elements. Specifically, as illustrated in FIG. 1, the information processing apparatus 100a extracts the data elements A1 and A2 from the divided data D110 and allocates the extracted data elements A1 and A2 to that apparatus, i.e., the information processing apparatus 100a. Furthermore, from among the divided data D110, the information processing apparatus 100a allocates the data elements B1 and B2 to the information processing apparatus 100b and allocates the data elements C1 and C2 to the information processing apparatus 100c.

Furthermore, the information processing apparatus 100b allocates the data elements, which are included in the divided data D120 and are transferred from the information processing apparatus 100a, to an information processing apparatus that process the data elements. Specifically, as illustrated in FIG. 1, the information processing apparatus 100b extracts the data elements A3 and A4 from the divided data D120 and allocates the extracted data elements A3 and A4 to the information processing apparatus 100a. Furthermore, the information processing apparatus 100b extracts the data elements C3 and C4 from the divided data D120 and allocates the extracted data elements C3 and C4 to the information processing apparatus 100c.

Each of the information processing apparatuses 100a to 100c preferably links the extracted data elements and then preferably distributes the linked data elements to the other information processing apparatuses. In the example illustrated in FIG. 1, the information processing apparatus 100a links the data element B1 to the data element B2 and allocates the linked data elements B1 and B2 to the information processing apparatus 100b. Because each of the information processing apparatuses 100a to 100c distributes linked data elements to the other information processing apparatuses, it is possible to enhance the communication efficiency.

Then, the information processing apparatuses 100a to 100c each processes the data elements that are allocated by each information processing apparatus. Specifically, the information processing apparatus 100a processes the data elements A1 and A2 allocated by the information processing apparatus 100a and processes the data elements A3 and A4 allocated by the information processing apparatus 100b. The information processing apparatus 100b processes the data elements B1 and B2 allocated by the information processing apparatus 100a and processes the data elements B3 and B4 allocated by the information processing apparatus 100b. The information processing apparatus 100c processes the data elements C1 and C2 allocated by the information processing apparatus 100a and processes the data elements C3 and C4 allocated by the information processing apparatus 100b.

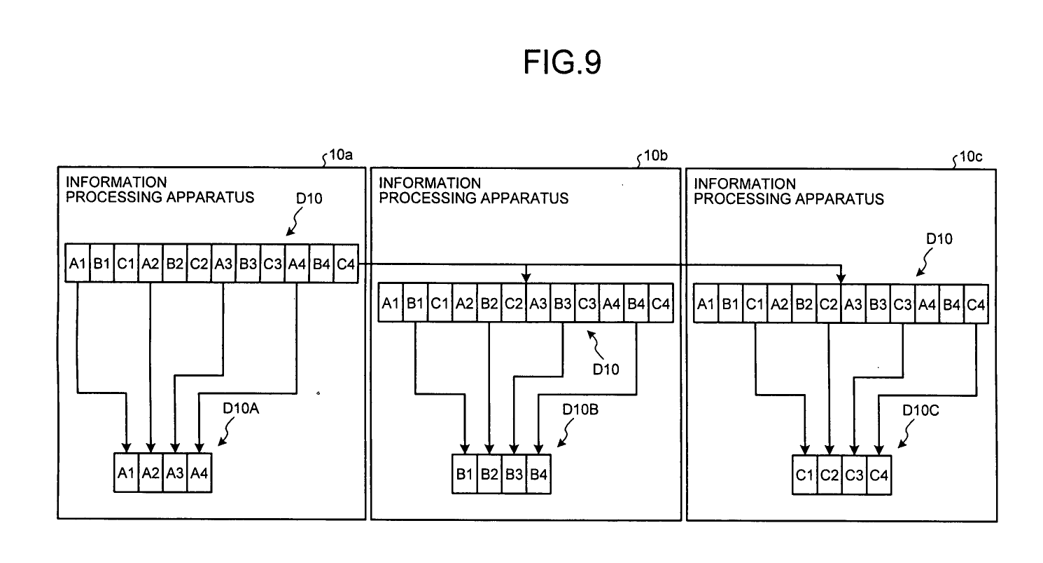

In this way, the distributed processing system 1 according to the first embodiment transfers a part of the divided data to be processed to the other information processing apparatuses and allocates, using a plurality of information processing apparatuses, data elements to an information processing apparatus that processes the data elements. Accordingly, it is possible to reduce the amount of data communication traffic when compared with the distributed processing illustrated in FIG. 9. Therefore, when compared with the distributed processing illustrated in FIG. 9, the distributed processing system 1 according to the first embodiment can reduce data transmission processing time, and thus it is possible to reduce the data processing time.

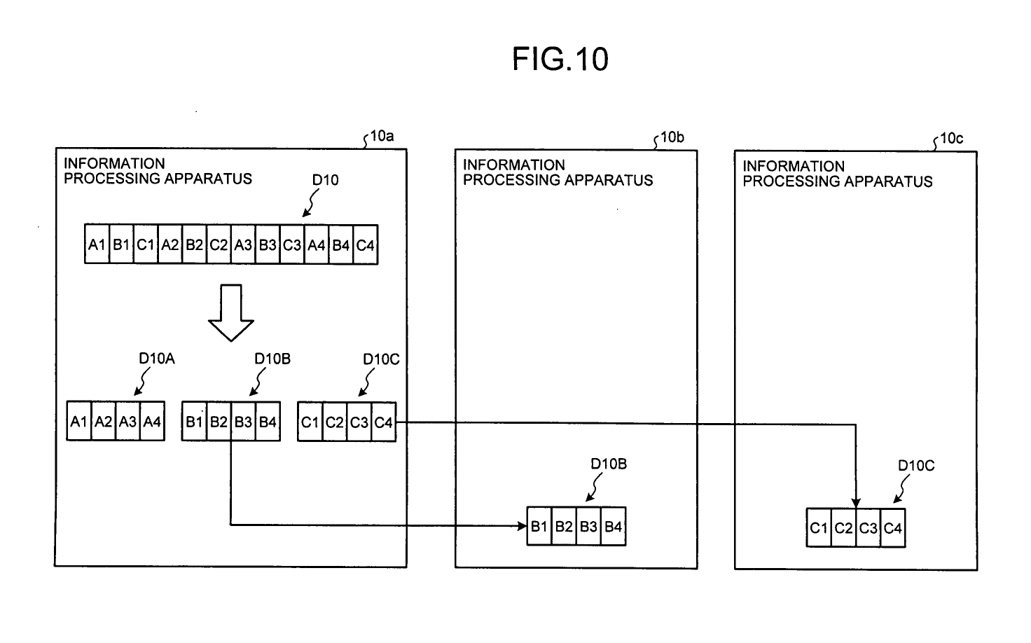

Furthermore, as described above, because the distributed processing system 1 according to the first embodiment uses a plurality of information processing apparatuses to process the allocation of data elements, it is possible to distribute, to the information processing apparatuses, the process load for allocating the data elements. Accordingly, when compared with the distributed processing illustrated in FIG. 10, because the distributed processing system 1 according to the first embodiment can process the allocation of data elements at high speed, it is possible to reduce the data processing time.

Furthermore, with the distributed processing system 1 according to the first embodiment, not all data to be processed are transmitted/received among the information processing apparatuses. Accordingly, when compared with the distributed processing illustrated in FIG. 9, it is possible to reduce memory usage.

Configuration of an Information Processing Apparatus 100 According to the First Embodiment

In the following, the configuration of an information processing apparatus 100 according to the first embodiment will be described with reference to FIG. 3. FIG. 3 is a schematic diagram illustrating the configuration of the information processing apparatus 100 according to the first embodiment. The information processing apparatus 100 illustrated in FIG. 3 corresponds to the information processing apparatuses 100a to 100c illustrated in FIG. 1.

As illustrated in FIG. 3, the information processing apparatus 100 includes an interface (hereinafter, referred to as an “I/F”) 110, a primary storing unit 120, a secondary storing unit 130, and a control unit 140.

The I/F 110 transmits and receives various kinds of data among other information processing apparatuses. In the example illustrated in FIG. 1, the information processing apparatus 100a transmits and receives various kinds of data to/from the information processing apparatuses 100b and 100c via the I/F 110.

The primary storing unit 120 is a storage device, such as a memory, that stores therein various kinds of information. The control unit 140, which will be described later, performs various processes by allowing the primary storing unit 120 to temporarily store therein various kinds of information.

The secondary storing unit 130 is a storage device, such as a hard disk, that stores therein various kinds of information. The secondary storing unit 130 according to the first embodiment includes a data storing unit 131. The data storing unit 131 stores therein data to be processed. For example, the data storing unit 131 stores therein the data D100 illustrated in FIGS. 1 and 2.

The control unit 140 performs the overall control of the information processing apparatus 100. The control unit 140 according to the first embodiment includes a transferring unit 141, an allocation unit 142, and a data processing unit 143.

The transferring unit 141 divides data to be processed, allocates the divided data to all or some of the information processing apparatuses arranged in the distributed processing system 1, and transfers the divided data allocated to a different information processing apparatus to the different information processing apparatus.

Specifically, the transferring unit 141 reads the data that is to be processed and that is stored in the data storing unit 131. Subsequently, the transferring unit 141 divides the read data into a predetermined number of data. The number of data to be divided can be freely determined. Then, the transferring unit 141 assigns the divided data to all or some of the information processing apparatuses in the distributed processing system 1. The transferring unit 141 transfers the divided data assigned to the different information processing apparatus to the different information processing apparatus to which the divided data has been assigned. In the first embodiment, the number of data divided by the transferring unit 141 is determined in advance.

A transfer process performed on the divided data by the transferring unit 141 will be described with reference to FIG. 1. In the example illustrated in FIG. 1, the transferring unit 141 in the information processing apparatus 100a divides the data D100 into two, i.e., the divided data D110 and the divided data D120. Subsequently, the transferring unit 141 assigns the divided data D110 to the information processing apparatus 100a and assigns the divided data D120 to the information processing apparatus 100b. Then, the information processing apparatus 100a transfers the divided data D120 assigned to the information processing apparatus 100b to the information processing apparatus 100b.

The transfer process performed by the transferring unit 141 is not limited to the example illustrated in FIG. 1. For example, the transferring unit 141 can assign the divided data D120 to the information processing apparatus 100c and transfer it thereto. Furthermore, the transferring unit 141 can also assign the divided data D110 to the information processing apparatus 100b or 100c that is other than the information processing apparatus 100a and transfer it to the information processing apparatus 100b or 100c. Furthermore, the transferring unit 141 can also assign the divided data D110 to the information processing apparatus 100b, transfer the divided data D110 to the information processing apparatus 100b, assign the divided data D120 to the information processing apparatus 100c, and transfer the divided data D120 to the information processing apparatus 100c.

The allocation unit 142 allocates, to an information processing apparatus that processes divided data or data elements, the divided data assigned by the transferring unit 141 to that apparatus that includes the corresponding transferring unit 141 or allocates the data elements included in the divided data transferred from a different information processing apparatus.

Specifically, if divided data is assigned by the transferring unit 141 to that apparatus that includes the corresponding transferring unit 141, the allocation unit 142 extracts data elements from the divided data and allocates the extracted data elements to an information processing apparatus that processes the data elements. In the first embodiment, as described above, because the information processing apparatus that processes the data elements is previously determined for each data element, the allocation unit 142 allocates a data element to a corresponding information processing apparatus that is previously determined.

Furthermore, if divided data is transferred from the transferring unit 141 in a different information processing apparatus, the allocation unit 142 extracts data elements from the transferred divided data and allocates each extracted data element to an information processing apparatus that processes the data element. As described above, it is also possible for the allocation unit 142 to link the data elements and then allocate the linked data elements.

An allocation process performed on data elements by the allocation unit 142 will be described with reference to FIG. 1. In the example illustrated in FIG. 1, the transferring unit 141 in the information processing apparatus 100a assigns the divided data D110 to the information processing apparatus 100a. Accordingly, the allocation unit 142 in the information processing apparatus 100a extracts each data element from the divided data D110 and allocates each data element to the corresponding information processing apparatus. Specifically, the allocation unit 142 in the information processing apparatus 100a extracts the data elements A1 and A2 from the divided data D110 and allocates the extracted data elements A1 and A2 to the information processing apparatus 100a. Furthermore, the allocation unit 142 in the information processing apparatus 100a extracts the data elements B1 and B2 from the divided data D110 and allocates the extracted data elements B1 and B2 to the information processing apparatus 100b. Furthermore, the allocation unit 142 in the information processing apparatus 100a extracts the data elements C1 and C2 from the divided data D110 and allocates the extracted data elements C1 and C2 to the information processing apparatus 100c.

In the example illustrated in FIG. 1, the information processing apparatus 100b receives the divided data D120 from the information processing apparatus 100a. Accordingly, the allocation unit 142 in the information processing apparatus 100b extracts the data elements A3 and A4 from the received divided data D120 and allocates the extracted data elements A3 and A4 to the information processing apparatus 100a. Furthermore, the allocation unit 142 in the information processing apparatus 100b extracts the data elements B3 and B4 from the divided data D120 and allocates the extracted data elements B3 and B4 to the information processing apparatus 100b. Furthermore, the allocation unit 142 in the information processing apparatus 100b extracts the data elements C3 and C4 from the divided data D120 and allocates the extracted data elements C3 and C4 to the information processing apparatus 100c.

The data processing unit 143 processes a data element that is allocated by the allocation unit 142 in that apparatus that includes the corresponding allocation unit 142 and a data element that is allocated by an allocation unit 142 in a different information processing apparatus. Specifically, if a data element is allocated by the allocation unit 142 in that apparatus that includes the corresponding allocation unit 142, the data processing unit 143 processes the allocated data element. Furthermore, if a data element is allocated by an allocation unit 142 in a different information processing apparatus, the data processing unit 143 processes the data element allocated by the different information processing apparatus.

Data processing performed by the data processing unit 143 will be described with reference to FIG. 1. In the example illustrated in FIG. 1, the data processing unit 143 in the information processing apparatus 100a processes the data elements A1 and A2 allocated by the allocation unit 142 in the information processing apparatus 100a. Furthermore, the data processing unit 143 in the information processing apparatus 100a processes the data elements A3 and A4 allocated by the allocation unit 142 in the different information processing apparatus 100b.

Furthermore, in the example illustrated in FIG. 1, the data processing unit 143 in the information processing apparatus 100b processes the data elements B1 and B2 allocated by the allocation unit 142 in the different information processing apparatus 100a. Furthermore, the data processing unit 143 in the information processing apparatus 100b processes the data elements B3 and B4 allocated by the allocation unit 142 by the information processing apparatus 100b.

Furthermore, in the example illustrated in FIG. 1, the data processing unit 143 in the information processing apparatus 100c processes the data elements C1 and C2 allocated by the allocation unit 142 in the different information processing apparatus 100a. Furthermore, the data processing unit 143 in the information processing apparatus 100c processes the data elements C3 and C4 allocated by the allocation unit 142 in the different information processing apparatus 100b.

Flow of Distributed Processing Performed by the Distributed Processing System 1 According to the First Embodiment

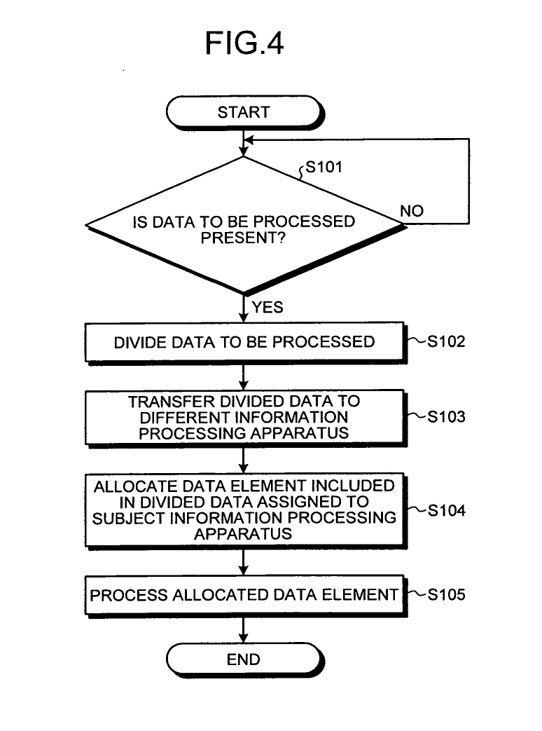

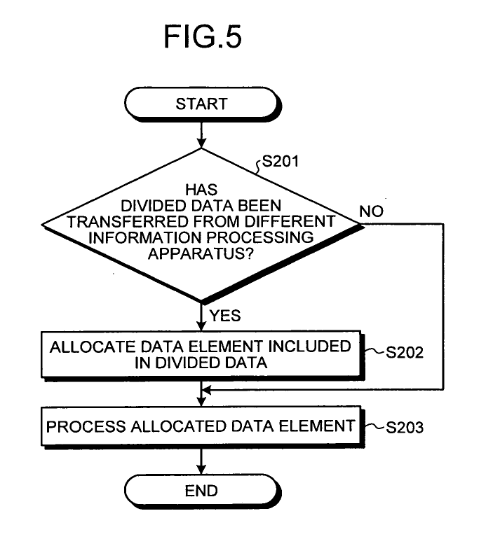

In the following, the flow of distributed processing performed by the distributed processing system 1 according to the first embodiment will be described with reference to FIGS. 4 and 5. FIG. 4 is a flowchart illustrating the flow of a process performed by the information processing apparatus 100 storing therein data to be processed. FIG. 5 is a flowchart illustrating the flow of a process performed by the information processing apparatus 100 to which divided data is transferred from a different information processing apparatus. For example, the flow of the process illustrated in FIG. 4 is that performed by the information processing apparatus 100a illustrated in FIG. 1. The flow of the process illustrated in FIG. 5 is that performed by the information processing apparatuses 100b and 100c illustrated in FIG. 1.

As illustrated in FIG. 4, if data to be processed is stored in the data storing unit 131 (Yes at Step S101), the transferring unit 141 in the information processing apparatus 100 divides the data into a predetermined number of data (Step S102). Then, the transferring unit 141 assigns the divided data to all or some of the information processing apparatuses in the distributed processing system 1 and transfers the divided data assigned to a different information processing apparatus to the different information processing apparatus (Step S103).

In the example illustrated in FIG. 1, the transferring unit 141 in the information processing apparatus 100a divides the data D100 into two, i.e., the divided data D110 and the divided data D120. Then, the transferring unit 141 assigns the divided D120 to the information processing apparatus 100b and transfers the divided data D120 to the information processing apparatus 100b.

Subsequently, the allocation unit 142 allocates data elements, which are included in the divided data assigned to that apparatus that includes the corresponding transferring unit 141 at Step S103, to an information processing apparatus that process the data elements (Step S104).

In the example illustrated in FIG. 1, among the data elements included in the divided data D110, the allocation unit 142 in the information processing apparatus 100a allocates the data elements A1 and A2 to be processed by the information processing apparatus 100a to the information processing apparatus 100a. Furthermore, the allocation unit 142 in the information processing apparatus 100a allocates the data elements B1 and B2 to be processed by the information processing apparatus 100b to the information processing apparatus 100b and allocates the data elements C1 and C2 to be processed by the information processing apparatus 100c to the information processing apparatus 100c.

Then, the data processing unit 143 processes the data elements allocated to the information processing apparatus that includes the corresponding data processing unit 143 by each allocation unit 142 in each information processing apparatus (Step S105). Specifically, the data processing unit 143 processes the data elements allocated, at Step S104, to information processing apparatus that processes the data elements and processes the data elements allocated to information processing apparatus that processes the data elements by the allocation unit 142 in a different information processing apparatus.

In the example illustrated in FIG. 1, for the divided data D110, the data processing unit 143 in the information processing apparatus 100a processes the data elements A1 and A2 allocated by the allocation unit 142 in the information processing apparatus 100a. Furthermore, the data processing unit 143 in the information processing apparatus 100a processes the data elements A3 and A4 allocated to the information processing apparatus 100a by the allocation unit 142 in the information processing apparatus 100b.

In the following, the flow of a process illustrated in FIG. 5 will be described. As illustrated in FIG. 5, if the divided data is transferred from a different information processing apparatus (Yes at Step S201), the allocation unit 142 in the information processing apparatus 100 allocates the data elements included in the transferred divided data to an information processing apparatus that processes the data elements (Step S202).

In the example illustrated in FIG. 1, the divided data D120 is transferred to the information processing apparatus 100b from the information processing apparatus 100a. Accordingly, from among the data elements included in the divided data D120, the allocation unit 142 in the information processing apparatus 100b allocates the data elements A3 and A4 to be processed by the information processing apparatus 100a to the information processing apparatus 100a. Furthermore, the allocation unit 142 in the information processing apparatus 100b allocates the data elements B3 and B4 to be processed by the information processing apparatus 100b to the information processing apparatus 100b and allocates the data elements C3 and C4 to the information processing apparatus 100c.

After the allocation unit 142 has allocated the data elements to a corresponding information processing apparatus (Step S202), the data processing unit 143 processes the data elements allocated to the information processing apparatus that includes the corresponding data processing unit 143 by each allocation unit 142 in each information processing apparatus (Step S203). Specifically, the data processing unit 143 processes the data elements allocated by the allocation unit 142 in the apparatus that includes the corresponding allocation unit 142 and processes the data element allocated to the apparatus that includes the corresponding allocation unit 142 by an allocation unit 142 in a different information processing apparatus.

In contrast, if the divided data is not transferred from a different information processing apparatus (No at Step S201), the data processing unit 143 does not perform the allocation process on the divided data and processes the data elements allocated to the apparatus that includes the corresponding allocation unit 142 by an allocation unit 142 in a different information processing apparatus (Step S203).

In the example illustrated in FIG. 1, the data processing unit 143 in the information processing apparatus 100b processes the data elements B1 and B2 that have been allocated to the information processing apparatus 100b by the allocation unit 142 in the information processing apparatus 100a. Furthermore, the data processing unit 143 in the information processing apparatus 100b processes the data elements B3 and B4 allocated by the allocation unit 142 in the information processing apparatus 100b.

Furthermore, in the example illustrated in FIG. 1, because the data processing unit 143 in the information processing apparatus 100c does not receive the divided data from the information processing apparatus 100a, the data processing unit 143 in the information processing apparatus 100c processes, without processing the allocation of the divided data, the data elements C1 and C2 allocated to the information processing apparatus 100c by the allocation unit 142 in the information processing apparatus 100a. Furthermore, the data processing unit 143 in the information processing apparatus 100c processes the data elements C3 and C4 allocated to the information processing apparatus 100c by the allocation unit 142 in the information processing apparatus 100b.

Advantage of the First Embodiment

As described above, the distributed processing system 1 according to the first embodiment transfers data to be processed to a plurality of information processing apparatuses 100 and distributes data elements using the information processing apparatuses 100. Accordingly, the distributed processing system 1 according to the first embodiment can distribute, to the information processing apparatuses, the load of the data distributed processing. As a result, the distributed processing system 1 according to the first embodiment can reduce the data processing time.

### [b] Second Embodiment

The distributed processing system and the like disclosed in the present invention can be implemented with various kinds of embodiments other than the embodiments described above. Accordingly, in a second embodiment, another embodiment of the distributed processing system and the like will be described.

Transfer Process 1

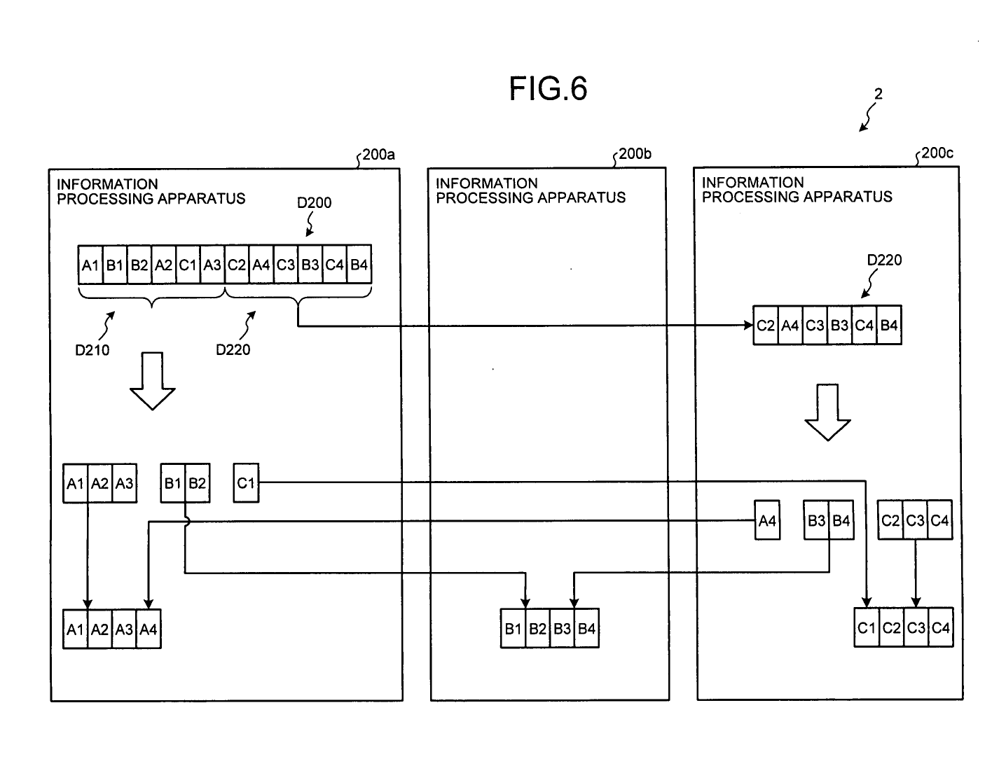

As described above in the first embodiment, the information processing apparatus 100 divides data to be processed and transfers the divided data allocated to a different information processing apparatus to the different information processing apparatus. At this time, it is also possible for the information processing apparatus to allocate, from among information processing apparatuses in the distributed processing system, the divided data to an information processing apparatus that processes more data elements in the divided data than those in the different information processing apparatuses and transfers the data elements to the information processing apparatus. This case will be described with reference to FIG. 6. FIG. 6 is a schematic diagram illustrating an example of distributed processing performed by a distributed processing system 2 according to the second embodiment.

As illustrated in FIG. 6, the distributed processing system 2 includes information processing apparatuses 200a to 200c. In this case, for data D200, it is assumed that the information processing apparatus 200a processes the data elements A1 to A4, that the information processing apparatus 200b processes the data elements B1 to B4, and that the information processing apparatus 200c processes the data elements C1 to C4.

Then, as illustrated in FIG. 6, it is assumed that the information processing apparatus 200a divides the data D200 into the divided data D210 and the divided data D220 and transfers the divided data D220 to a different information processing apparatus. Here, the divided data D220 includes the data elements A4, B3 and B4, and C2 to C4. Specifically, the divided data D220 includes one data element to be processed by the information processing apparatus 200a, includes two data elements to be processed by the information processing apparatus 200a, and includes three data elements to be processed by the information processing apparatus 200c. In such a case, from among the data elements included in the divided data D220, the information processing apparatus 200a assigns the divided data D220 to the information processing apparatus 200c that processes the largest number of data elements.

The distributed processing system 2 can reduce the amount of data communication traffic by transferring the divided data to be processed in this way. To clarify the advantage, a description will be given by comparing a case in which the divided data D220 is transferred to the information processing apparatus 200b with a case in which the divided data D220 is transferred to the information processing apparatus 200c, and then the amount of data communication traffic performed in both cases will be described.

First, when the divided data D220 is transferred to the information processing apparatus 200b, the information processing apparatus 200b allocates the data element A4 included in the divided data D220 to the information processing apparatus 200a and allocates the data elements C2 to C4 to the information processing apparatus 200c. In other words, in this case, the information processing apparatus 200b allocates four data elements to different information processing apparatuses.

Furthermore, as illustrated in FIG. 6, when the divided data D220 is transferred to the information processing apparatus 200c, the information processing apparatus 200c allocates the data element A4 included in the divided data D220 to the information processing apparatus 200a and allocates the data elements B3 and B4 to the information processing apparatus 200b. In other words, the information processing apparatus 200c allocates three data elements to different information processing apparatuses.

This shows that the total amount of data communication traffic is less in a case where the divided data D220 is transferred to the information processing apparatus 200c than in a case where the divided data D220 is transferred to the information processing apparatus 200b. In the example illustrated in FIG. 6, in order to simplify the description, a case in which the size of the divided data D200 is small is described as an example; however, in practice, the size of the divided data D200 is huge. Accordingly, a big difference may occur in the amount of data communication traffic.

Because the distributed processing system 2 can reduce the amount of data communication traffic in this way, it is possible to speed up the allocation process on data elements. Accordingly, the distributed processing system 2 can reduce the data processing time.

Transfer Process 2

Furthermore, the information processing apparatus can also allocate the divided data to an information processing apparatus having high processing performance. For example, in the example illustrated in FIG. 1, if the performance of the information processing apparatus 100b is higher than that of the information processing apparatus 100c, the information processing apparatus 100a allocates the divided data D120 to the information processing apparatus 100b and transfers the divided data D120 to the information processing apparatus 100b. In contrast, if the performance of the information processing apparatus 100c is higher than that of the information processing apparatus 100b, the information processing apparatus 100a allocates the divided data D120 to the information processing apparatus 100c and transfers the divided data D120 to the information processing apparatus 100c. In this way, because it is possible to speed up the allocation process of data elements, data processing time can thus be reduced.

Transfer Process 3

In the above, the description has been given with the assumption that the number of data divided is determined in advance; however, the number of data divided is not limited thereto. The information processing apparatus can also determine the number of data divided in accordance with the size. For example, if the data size is less than 10 megabytes (MB), the information processing apparatus can divide the data to be processed into two. If the data size is equal to or larger than 10 (MB) and less than 100 (MB), the information processing apparatus can divide the data to be processed into three. Furthermore, if the data size is less than 5 (MB), the information processing apparatus can allocate, without dividing the data to be processed, the data elements to each information processing apparatus. Accordingly, the distributed processing system can efficiently process the allocation of the data elements. For example, if the data size is small, a single information processing apparatus allocates the data elements to each information processing apparatus; therefore, it is possible to reduce the amount of data communication traffic.

Furthermore, the information processing apparatus divides the data to be processed in a range from “1” to “the number of information processing apparatuses included in the distributed processing system”. Specifically, in the example illustrated in FIG. 1, the information processing apparatus 100a divides the data D100 into a maximum of three.

Link Process

In the first embodiment, a description has been given with the assumption that the order of processing the data elements is not determined. However, if the order of processing the data elements is determined, the information processing apparatus 100 sorts the data elements into the order they are to be processed and then performs the data processing. Specifically, after the information processing apparatus 100 receives, from a different information processing apparatus, all of the data elements allocated to the information processing apparatus 100, the information processing apparatus 100 sorts the data elements into the order they are to be processed.

In the following description, it is assumed that the data elements are processed in the ascending order of the number assigned after the reference numeral. For example, in the example illustrated in FIG. 1, it is assumed that the information processing apparatus 100a processes the data elements in the order of A1, A2, A3, and A4. Similarly, it is assumed that the information processing apparatus 100b processes the data elements in the order of B1, B2, B3, and B4, and that the information processing apparatus 100c processes the data elements in the order of C1, C2, C3, and C4.

In such a case, after receiving the data elements A3 and A4 from the information processing apparatus 100b, the information processing apparatus 100a links the data elements in the order of data elements A1, A2, A3, and A4. Furthermore, after receiving the data elements B1 and B2 from the information processing apparatus 100a, the information processing apparatus 100b links the data elements in the order of data elements B1, B2, B3, and B4. Furthermore, after receiving the data elements C1 and C2 from the information processing apparatus 100a and further after receiving the data elements C3 and C4 from the information processing apparatus 100b, the information processing apparatus 100c links the data elements in the order of data elements C1, C2, C3, and C4.

Furthermore, it is also possible for the information processing apparatus 100 to link the data elements in the order they are to be processed and then to allocate the linked data elements. For example, in the example illustrated in FIG. 1, after linking the data elements in the order of data elements B1 and B2, the information processing apparatus 100a allocates the linked data elements B1 and B2 to the information processing apparatus 100b. Similarly, after linking the data elements in the order of data elements C1 and C2, the information processing apparatus 100a allocates the linked data elements C1 and C2 to the information processing apparatus 100c. Accordingly, each information processing apparatus can efficiently sort the data elements.

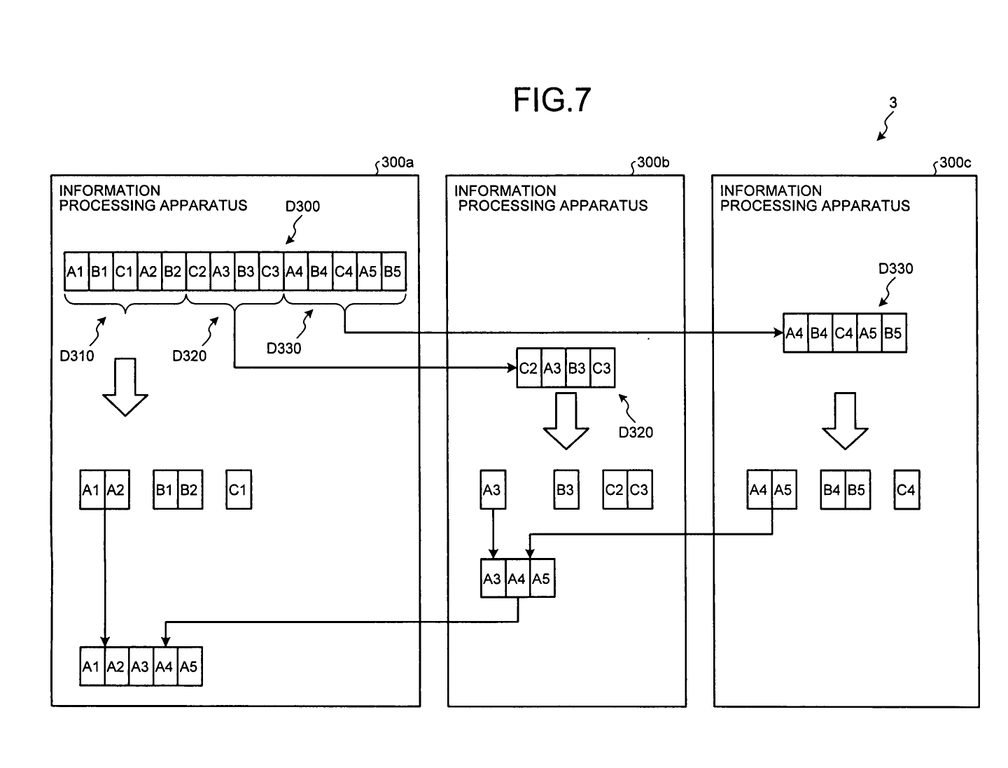

Furthermore, the information processing apparatus 100 can also gradually perform a data link process by using a plurality of information processing apparatuses. This will be specifically described with reference to FIG. 7. FIG. 7 is a schematic diagram illustrating an example of distributed processing performed by a distributed processing system 3 according to the second embodiment.

As illustrated in FIG. 7, the distributed processing system 3 includes information processing apparatuses 300a to 300c. In this case, for data D300, it is assumed that the information processing apparatus 300a processes data elements A1 to A5, that the information processing apparatus 300b processes data elements B1 to B5, and that the information processing apparatus 300c processes data elements C1 to C4.

In the example illustrated in FIG. 7, the information processing apparatus 300a divides the data D300 into divided data D310, divided data D320, and divided data D330. Then, the information processing apparatus 300a transfers the divided data D320 to the information processing apparatus 300b and transfers the divided data D330 to the information processing apparatus 300c.

For the divided data D330, the information processing apparatus 300c allocates the data elements A4 and A5 to the information processing apparatus 300b. The information processing apparatus 300b links, in the order they are to be processed, the data element A3 included in the divided data D320 and the data elements A4 and A5 transferred from the information processing apparatus 300c. Specifically, the information processing apparatus 300b links the data elements in the order of data elements A3, A4, and A5. Then, the information processing apparatus 300b transfers the linked data elements A3, A4, and A5 to the information processing apparatus 300a.

It is effective to use the data link process illustrated in FIG. 7 for a distributed processing system that includes, for example, information processing apparatuses having different performance capacities. For example, in the example illustrated in FIG. 7, if the performance capacity of the information processing apparatus 300b is higher than that of the information processing apparatus 300c, by allowing the information processing apparatus 300b to perform the data link process, it is possible to implement such a data link process at high speed.

Furthermore, it is also possible to use the data link process illustrated in FIG. 7 even in a case when information processing apparatuses that have the same performance capacity are used. For example, in the example illustrated in FIG. 7, if a higher load is applied to the information processing apparatus 300c than the information processing apparatus 300b, by allowing the information processing apparatus 300b to perform the data link process, it is possible to reduce the load on the information processing apparatus 300c. Accordingly, data processing time can be reduced.

Multiprocessor

Furthermore, it is also possible to use the above described data distributed processing for an information processing apparatus that processes, using a plurality of processors, data by dividing it into multiple data or for an information processing apparatus that includes a multi-core processor.

Program

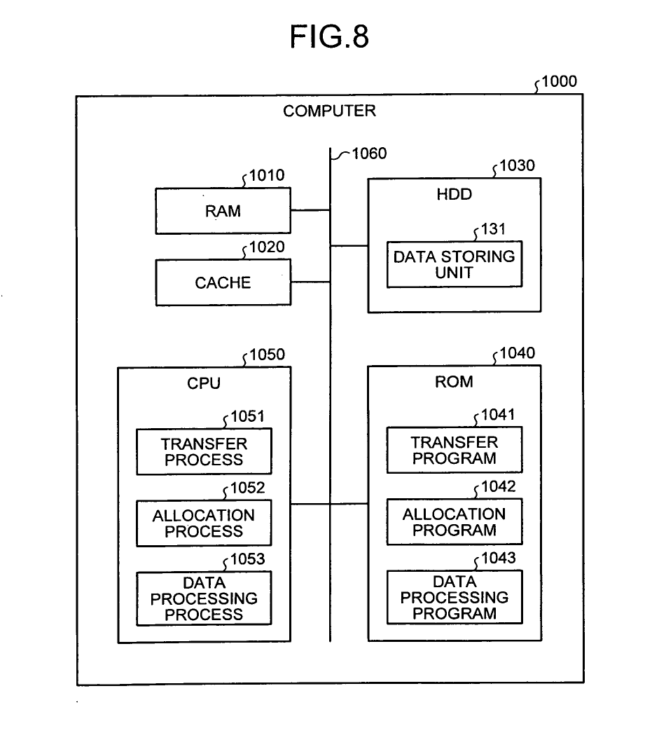

The various processes described in the first embodiment can be implemented by programs prepared in advance and executed by a computer such as a personal computer or a workstation. Accordingly, in the following, a computer that executes a distributed processing program having the same function performed by the information processing apparatus 100 in the first embodiment will be described as an example using FIG. 8.

FIG. 8 is a schematic diagram illustrating a computer that executes a distributed processing program. As illustrated in FIG. 8, a computer 1000 includes a random access memory (RAM) 1010, a cache 1020, an HDD 1030, a read only memory (ROM) 1040, and a central processing unit (CPU) 1050, which are connected via a bus 1060.

The ROM 1040 stores therein, in advance, a distributed processing program having the same function as that performed by the information processing apparatus 100 in the first embodiment. Specifically, the ROM 1040 stores therein a transfer program 1041, an allocation program 1042, and a data processing program 1043.

Then, the CPU 1050 reads the transfer program 1041, the allocation program 1042, and the data processing program 1043 and executes them. Accordingly, as illustrated in FIG. 8, the transfer program 1041 functions as a transfer process 1051, the allocation program 1042 functions as an allocation process 1052, and the data processing program 1043 functions as a data processing process 1053.

The transfer process. 1051 corresponds to the transferring unit 141 illustrated in FIG. 3, the allocation process 1052 corresponds to the allocation unit 142 illustrated in FIG. 3, and the data processing process 1053 corresponds to the data processing unit 143 illustrated in FIG. 3.

As illustrated in FIG. 8, the data storing unit 131 illustrated in FIG. 3 is arranged in the HDD 1030.

The above-described programs 1041 to 1043 are not necessarily stored in the ROM 1040. For example, the program 1041 or the like can be stored in a “portable physical medium” such as a flexible disk (FD), a CD-ROM, a magneto-optic (MO) disk, a DVD disk, an IC CARD, or the like that can be inserted into the computer 1000. Alternatively, the program 1041 or the like can also be stored in a “fixed physical medium” such as a hard disk drive (HDD) that can be arranged inside/outside the computer 1000. Alternatively, the program 1041 or the like can also be stored in “another computer (or a server)” connected to the computer 1000 via a public circuit, the Internet, a LAN, or a WAN. Then the computer 1000 can read and execute each program from the flexible disk or the like described above.

A distributed processing system disclosed in the present invention provides an advantage in that the data processing time can be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention

What is claimed is:

1. A distributed processing system including a plurality of information processing apparatuses, each of the information processing apparatuses comprising:
a transferring unit that divides data to be processed including data elements for each of which one of the information processing apparatuses is set for processing, that assigns divided data to the information processing apparatuses in the distributed processing system, and that transfers the divided data assigned to a different information processing apparatus to the different information processing apparatus;
an allocation unit that allocates the data elements included in the divided data which is assigned to own information processing apparatus by the transferring unit in the own information processing apparatus or by the transferring unit in a different information processing apparatus, to an information processing apparatus that processes the data element; and
a data processing unit that processes the allocated data elements.

2. The distributed processing system according to claim 1, wherein the transferring unit allocates the divided data to an information processing apparatus that processes relatively more data elements from among the data elements included in the divided data.

3. The distributed processing system according to claim 1, wherein the transferring unit assigns the divided data to an information processing apparatus that has a higher performance.

4. The distributed processing system according to claim 1, wherein the transferring unit determines the number of data divided for the data to be processed in accordance with the size of the data to be processed.

5. The distributed processing system according to claim 1, wherein the allocation unit links the data elements included in the divided data assigned to the own information processing apparatus in an order in which the data elements are to be processed, and allocates the linked data elements to an information processing apparatus that processes the data elements.

6. A non-transitory computer readable storage medium having stored therein a distributed processing program for, an information processing apparatus that performs a process in a distributed manner with a different information processing apparatus, the distributed processing program causing the information processing apparatus to execute a process comprising:
dividing data to be processed including data elements corresponding to the data for each of which one of the information processing apparatuses is set for processing, assigning divided data corresponding to the data that has been divided to all or some of the information processing apparatuses including the information processing apparatus, and transferring the divided data assigned to a different information processing apparatus to the different information processing apparatus;
allocating the data elements included in the divided data, which is assigned to the information processing apparatus by the information processing apparatus or by a different information processing apparatus at the transferring, to an information processing apparatus that processes the data element; and
processing the data element allocated, at the allocating, by the information processing apparatus or by the different information processing apparatus.

7. An information processing apparatus that performs a process in a distributed manner with the other information processing apparatus, the information processing apparatus comprising:
a processor; and
a memory,
wherein the processor executes a process comprising:
dividing data to be processed to a plural data portions;
transferring at least one data portion to the other information processing apparatus, while retaining a remaining data portion;
extracting data element to be processed by the other information processing apparatus from the retained data portion;
transferring the extracted data element to the other information processing apparatus that processed the extracted data element, while retaining data element to be processed by the information processing apparatus included in the retained data portion; and
processing the retained data element and data element to be processed by the information processing apparatus transmitted from the other information processing apparatus.
